(19) United States
(12) Patent Application Publication
(10) Pub. No.: US 2011/0264845 A1
(43) Pub. Date: Oct. 27, 2011

(54) NONVOLATILE MEMORY DEVICE HAVING OPERATION MODE CHANGE FUNCTION AND OPERATION MODE CHANGE METHOD

(75) Inventor: Chang-Eun CHOI, Seoul (KR)

(73) Assignee: Samsung Electronics Co., Ltd, Suwon-si (KR)

(21) Appl. No.: 13/036,247

(22) Filed: Feb. 28, 2011

(30) Foreign Application Priority Data
Apr. 27, 2010 (KR) 2010-39102

(51) Int. Cl. G06F 12/00

(52) U.S. Cl. 711/103; 711/E12.008

(57) ABSTRACT

A nonvolatile semiconductor memory device changes an operation mode according to method type of operation to be performed. The semiconductor memory device includes a cache register for supporting a cache operation mode. The cache register and the memory cell array operate in the cache operation mode according to a first operation command. The memory cell array operates in an operation mode different from the cache operation mode according to a second operation command.

### CROSS-REFERENCE TO RELATED APPLICATIONS

This U.S. non-provisional patent application claims the benefit of priority under 35 U.S.C. §119 of Korean Patent Application No. 10-2010-0039102, filed on Apr. 27, 2010, the entire contents of which are hereby incorporated by reference.

### BACKGROUND

1. Field of the Invention

The present disclosure herein relates to a semiconductor memory, and more particularly, to a nonvolatile semiconductor memory device having a function of changing an operation mode according to a type of operation performed and to an operation mode change method of a semiconductor memory device.

2. Description of the Related Art

Typically, semiconductor memory devices are implemented with semiconductor materials such as silicon (Si), germanium (Ge), gallium arsenide (GaAs) and indium phosphide (InP).

Semiconductor memory devices are largely divided into volatile memory devices and nonvolatile memory devices.

Volatile memory devices are devices in which stored data are erased when a power source is shut off. Examples of volatile memory devices include Static Random Access Memory (SRAM), Dynamic Random Access Memory (DRAM) and Synchronous Dynamic Random Access Memory (SDRAM).

Nonvolatile memory devices are memory devices that retain stored data even when a power source is shut off. Examples of nonvolatile memory devices include Read-Only Memory (ROM), Programmable Read Only Memory (PROM), Erasable Programmable Read Only Memory (EPROM), Electrical Erasable Programmable Read Only Memory (EEPROM), flash memory device, Phase-change Random Access Memory (PRAM), Magnetoresistive Random Access Memory (MRAM), Resistive Random Access Memory (RRAM) and Ferroelectric Random Access Memory (FRAM).

In nonvolatile memory devices, stored data may be permanent or reprogrammable depending on the memory manufacturing technology or method. Nonvolatile semiconductor memory devices are used for storing programs and micro codes in a wide range of applications for technical industries such as computers, avionics, communications, and consumer electronics.

In PROM and EPROM among nonvolatile semiconductor memory devices, it is not easy for users to newly change the state of data stored in a memory cell because erasure and writing are not free in the system itself. On the other hand, since EEPROM is a memory device that provides for electrically erasing and writing data, its application is increasingly expanded. For example, EEPROM may be used in system programming fields requiring a continuous update and the auxiliary memory fields of a system.

Among nonvolatile memory devices, a flash memory device is an EEPROM having characteristic in which data stored in a plurality of memory regions may be erased at once. Due to features that provide physical impact resistibility and fast read access time, the flash memory device is being widely used as the data storage device of a system that receives a power source from a battery. The flash memory device may be divided into various kinds based on the connection types of memory cells configuring a memory cell array, and mainly, it is categorized into a NOR type flash memory device and a NAND type flash memory device.

In flash memory devices, when a cell transistor serving as a memory cell stores 1-bit data, the memory cell is called a single level cell, but when the cell transistor serving as the memory cell stores data of 2 bits or more, the memory cell is called a multi-level cell. When a memory cell array is a multi-level cell flash memory device including a plurality of multi-level cells, the charge amount of electrons trapped in the floating gate of a memory cell transistor is differentiated depending on the number of multi levels.

The operation performances of nonvolatile semiconductor memory devices such as flash memory devices largely affect the performances of data processing systems such as mobile devices that are applied to the nonvolatile semiconductor memory devices.

Particularly, nonvolatile semiconductor memory devices including an internal cache register may execute both a writing operation and a moving operation of data to perform operations requested from a host. The operations may be realized in a cache operation mode or a high frequency operation mode, and improved technology for processing works at a higher speed is urgently required.

### SUMMARY

The present disclosure provides a nonvolatile semiconductor memory device and a data processing system applying the same, which improve operation performance.

The present disclosure also provides a nonvolatile semiconductor memory device having a function of changing an operation mode according to the kinds of operations, and an operation mode change method.

The present disclosure also provides a method which can select an optimal operation mode according to the kinds of operations when processing a work requested by a host, and a mobile device including a data processing system.

The present disclosure also provides a method and a nonvolatile semiconductor memory device, which can increase a data processing speed in a writing operation or a moving operation.

The present disclosure also provides a memory controller which performs control in order for the data processing speed of a nonvolatile semiconductor memory device to increase in a writing operation or a moving operation.

The present disclosure also provides one NAND flash memory device which performs a cache operation mode in a writing operation and performs a high frequency operation mode in a moving operation.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a method of driving a nonvolatile semiconductor memory device, which includes a cache register for supporting a cache operation mode, the method including driving the nonvolatile semiconductor memory device in the cache operation mode according to a first operation command and driving the nonvolatile semiconductor memory device in an operation mode different from the cache operation mode according to a second operation command.

The first operation command may be a writing operation command.

The second operation command may be a moving operation command when the first operation command is a writing operation command.

The operation mode different from the cache operation mode may be a Double Data Rate (DDR) operation mode.

An operation clock frequency, which is used in the nonvolatile semiconductor memory device under the second operation command, may differ from an operation clock frequency which is used in the nonvolatile semiconductor memory device under the first operation command.

An operation clock frequency, which is used in the nonvolatile semiconductor memory device under the second operation command, may be higher than an operation clock frequency which is used in the nonvolatile semiconductor memory device under the first operation command.

The nonvolatile semiconductor memory device may be a NAND flash memory device.

A memory device configuring the cache register may be configured in a type different from type of a memory cell which configures a memory cell array of the nonvolatile semiconductor memory device.

Features and/or utilities of the present general inventive concept may also be realized by a nonvolatile semiconductor memory device including a cache register supporting a cache operation mode, a memory cell array including a plurality of memory blocks which include a plurality of memory cells nonvolatilely storing data, and a control driver driving the cache register and the memory cell array in the cache operation mode according to a first operation command, and driving the memory cell array in an operation mode different from the cache operation mode according to a second operation command.

The first operation command may be a writing operation command which indicates loading of data into the cache register and writing of the loaded data in the memory cell array.

When the first operation command is a writing operation command, the second operation command may be a moving operation command which indicates reading of data and writing of the read data in another memory cell.

The operation mode different from the cache operation mode may be a DDR operation mode.

An operation clock frequency, which is used under the second operation command, may differ from an operation clock frequency which is used under the first operation command.

An operation clock frequency, which is used in the nonvolatile semiconductor memory device under the second operation command, may be higher than an operation clock frequency which is used in the nonvolatile semiconductor memory device under the first operation command.

A memory device configuring the cache register may include a latch type of volatile memory cell.

Features and/or utilities of the present general inventive concept may also be realized by a data processing system including a nonvolatile semiconductor memory device including a cache register supporting a cache operation mode, and a memory cell array including a plurality of memory blocks which include a plurality of memory cells nonvolatilely storing data and a memory controller to control the nonvolatile semiconductor memory device to operate in the cache operation mode according to a first operation command, and in an operation mode different from the cache operation mode according to a second operation command.

An operation clock frequency, which is used in the nonvolatile semiconductor memory device under the second operation command, may be higher than an operation clock frequency which is used in the nonvolatile semiconductor memory device under the first operation command.

The nonvolatile semiconductor memory device may be one NAND flash memory device.

When the first operation command is a writing operation command which indicates loading of data into the cache register and writing of the loaded data in the memory cell array, the second operation command may be a moving operation command which indicates reading of data and writing of the read data in another memory cell.

The data processing system may be included in a mobile device.

Features and/or utilities of the present general inventive concept may also be realized by a method of controlling a memory device, including receiving a command to perform an operation of the memory device, determining whether the command corresponds to a first type of operation, and when the command corresponds to the first type of operation, performing the operation in a cache mode, and when the command does not correspond to the first type of operation, performing the operation in a non-cache mode.

Performing the operation in the cache mode may include selecting a first clock signal to perform the operation, and performing the operation in the non-cache mode may include selecting a second clock signal different from the first clock signal to perform the operation.

The second clock signal may have a frequency higher than the first clock signal.

The first operation may be a write operation to write data into a memory block of the memory device.

The method may further include, after receiving the command, determining whether a hybrid mode is set, and when it is determined that the hybrid mode is set, determining whether the command corresponds to the first type of operation, and when it is determined that the hybrid mode is not set, setting the mode to a predetermined one of the cache mode and the non-cache mode to perform the operation without determining whether the command corresponds to the first type of operation.

Features and/or utilities of the present general inventive concept may also be realized by a nonvolatile memory device, including a memory cell array to store data, and a control unit to receive a command to perform an operation, to execute the operation in a cache mode when the operation is a first type of operation, and to execute the operation in a non-cache mode when the operation is not the first type of operation.

The non-volatile memory device may also include a clock generator to generate a first clock signal having a first frequency and a second clock signal having a second frequency different from the first clock signal and a clock selection circuit to select and output the first clock signal to execute the operation when the operation is performed in the cache mode, and to select and output the second clock signal to execute the operation when the operation is performed in the non-cache mode.

The non-volatile memory device may also include a cache register, and performing the operation in the cache mode may include storing data in the cache register and transmitting the data from the cache register to the memory cell array to store the data in the memory cell array.

Features and/or utilities of the present general inventive concept may also be realized by a memory controller including a control circuit to receive a command to perform an operation corresponding to a nonvolatile memory controlled by the memory controller, to determine whether the operation corresponds to a predetermined operation type, and to output a first mode determination signal to perform the operation in a cache mode when the operation corresponds to the predetermined type and to output a second mode determination signal to perform the operation in a non-cache mode when the operation does not correspond to the predetermined type.

The memory controller may also include a clock generator to generate a first clock signal having a first frequency and a second clock signal having a second frequency different from the first clock signal and a clock selection circuit to select and output the first clock signal to execute the operation when the operation corresponds to the predetermined operation type, and to select and output the second clock signal to execute the operation when the operation does not correspond to the predetermine operation type.

The memory controller may also include a register to store data indicating whether a hybrid mode is selected. The control circuit may detect whether the hybrid mode is selected, and when the hybrid mode is selected, the control circuit may determine whether the operation corresponds to the predetermined type of operation, and when the hybrid mode is not selected, the control circuit may output a predetermined one of the first and second mode determination signals regardless of whether the operation corresponds to the predetermined type of operation.

Features and/or utilities of the present general inventive concept may also be realized by an electronic device including a nonvolatile memory device to store data, and a memory controller to receive a command to control the nonvolatile memory to perform an operation, to determine whether the operation corresponds to a predetermined operation type, and to output a first mode determination signal to control the nonvolatile memory device to perform the operation in a cache mode when the operation corresponds to the predetermined type and to output a second mode determination signal to control the nonvolatile memory device to perform the operation in a non-cache mode when the operation does not correspond to the predetermined type.

Features and/or utilities of the present general inventive concept may also be realized by a memory device, including a memory cell array, and a controller to control the memory cell array to perform a first operation using a first clock having a first speed in a first mode, and to perform a second operation different from the first operation using a second clock having a second speed different from the first speed in a second mode different from the first mode.

### BRIEF DESCRIPTION OF THE DRAWINGS

The accompanying drawings are included to provide a further understanding of the general inventive concept, and are incorporated in and constitute a part of this specification.

The drawings illustrate exemplary embodiments of the general inventive concept and, together with the description, serve to explain principles of the general inventive concept. In the drawings:

FIG. 1 is a block diagram schematically illustrating a data processing system applying an embodiment of the present general inventive concept;

FIG. 2 is a detailed block diagram illustrating specific examples of some elements of FIG. 1;

FIG. 3 is a flowchart illustrating a control operation of a memory controller in FIG. 2;

FIG. 4 is a diagram exemplarily illustrating a portion of a cell connection structure of a NAND type flash memory;

FIG. 5 is a diagram exemplarily illustrating a portion of a cell connection structure of a NOR type flash memory;

FIG. 6 is a diagram showing improvement in performance according to an embodiment of the inventive concept;

FIG. 7 is a detailed block diagram illustrating other specific examples of some elements of FIG. 1;

FIG. 8 is a flowchart illustrating a control operation of a nonvolatile semiconductor memory in FIG. 7;

FIG. 9 is a block diagram schematically illustrating a mobile device which may apply embodiments of the present general inventive concept;

FIG. 10 is a block diagram schematically illustrating another mobile device which may apply embodiments of the present general inventive concept; and

FIG. 11 is a flowchart illustrating a control operation of a nonvolatile memory according to another embodiment of the present general inventive concept.

### DETAILED DESCRIPTION OF THE EMBODIMENTS

Exemplary embodiments of the present general inventive concept will be described below in more detail with reference to the accompanying drawings. The present general inventive concept may, however, be embodied in different forms and should not be construed as limited to the embodiments set forth herein. Rather, these embodiments are provided so that this disclosure will be thorough and complete, and will fully convey the scope of the present general inventive concept to those skilled in the art.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.).

Moreover, it is also noted that like reference numerals denote like elements in the drawings. In some figures, relationships between elements and lines is merely illustrated for effectively describing technical content, and other elements or circuit blocks may be further included.

An embodiment described and exemplified herein may include a complementary embodiment thereof. The typical circuit configuration of a nonvolatile semiconductor memory device and reading, writing, and erasing operations based on the same will be omitted in order not to unnecessarily obscure subject matters of the present general inventive concept.

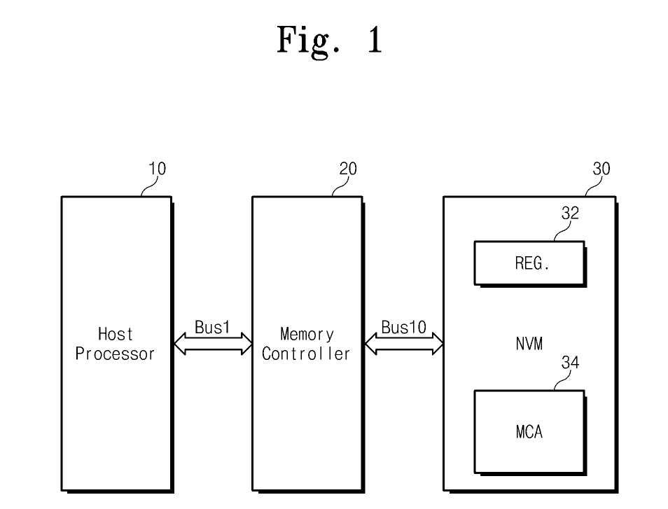

FIG. 1 is a block diagram schematically illustrating a data processing system applying an embodiment of the present general inventive concept.

Referring to FIG. 1, a data processing system, which may be mounted on mobile devices such as smart phones or may be included in any other electrical device, includes a host processor 10, a memory controller 20, and a nonvolatile semiconductor memory device 30 (hereinafter referred to as NVM).

The NVM 30 may include a cache register 32 for supporting a cache operation mode, and a memory cell array (MCA) 30 including memory blocks that include a plurality of memory cells that store data in a non-volatile manner, or in other words, in a manner such that the data is not erased when power is not supplied to the memory cells.

The memory controller 20 is connected to the host processor 10 through a bus BUS1. The memory controller 20 may control the NVM 30 to operate in a cache operation mode according to a first operation command such as a writing operation command, and to operate in a high frequency operation mode (for example, a Double Data Rate (DDR) operation mode) different from the cache operation mode according to a second operation command such as a moving operation command to move data from one memory location to another. The memory controller 20 is connected to a bus BUS10 to control the NVM 30.

As a result, when the writing operation is performed in the cache operation mode and a moving operation is performed in the high frequency operation mode, a time that is taken in processing a work requested by the host processor 10 can be shortened or minimized.

This is because the operation processing speed of the memory controller 21 and/or the nonvolatile memory 31 is faster when a moving or copying operation is performed in a high-frequency mode as compared to the cache operation mode.

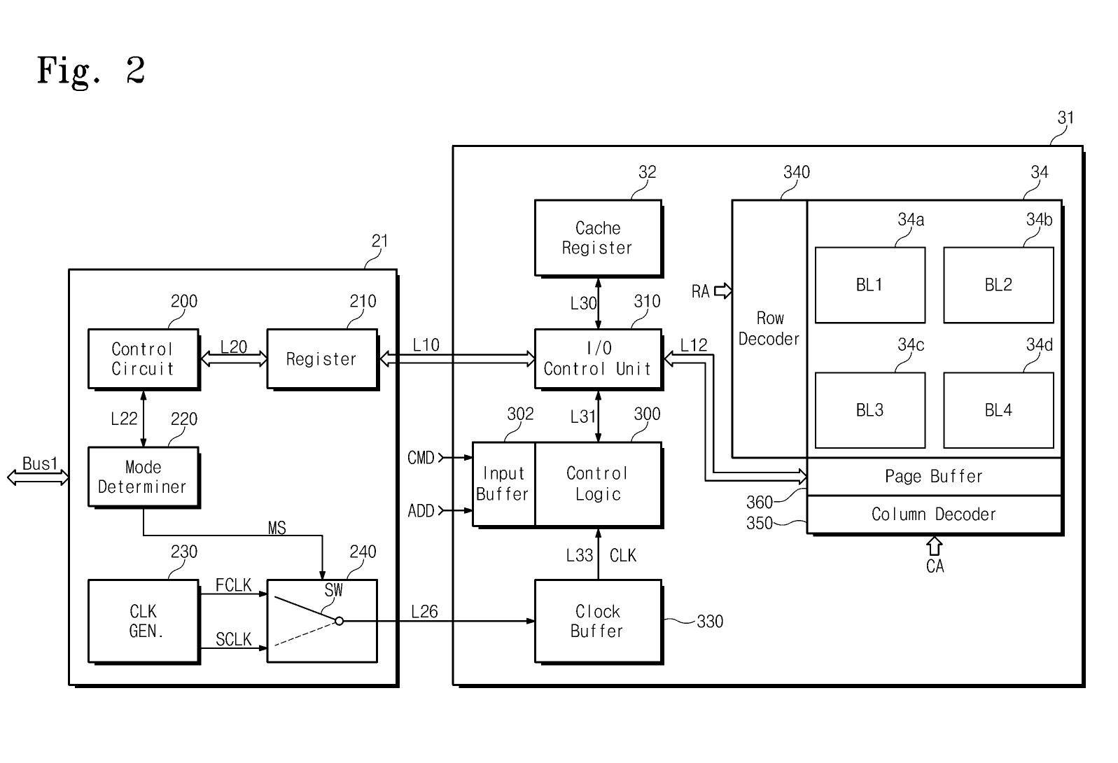

FIG. 2 is a detailed block diagram illustrating specific examples of some elements of FIG. 1.

Referring to FIG. 2, a memory controller 21 includes a control circuit 200, a register 210, a mode determiner 220, a clock generator 230, and a clock switch 240.

An NVM 31 includes a cache register 32, a memory cell array 34, control logic 300, an input buffer 302, an input/output (I/O) control unit 310, a clock buffer 330, a row decoder 340, a column decoder 350, and a page buffer 360.

When the memory controller 21 applies a writing operation command to the NVM 31, the mode determiner 220 of the memory controller 21 is controlled by the control circuit 200 through a line L22 and outputs a mode determination signal MS through a line L24. Therefore, the clock switch 240 switches and outputs a first operation clock frequency FCLK to a line L26. The frequency of the first operation clock FCLK may be lower than the frequency of a second operation clock SCLK outputted from the clock generator 230. When the writing operation command is applied to the NVM 31, a write data to be stored in a memory block selected from among memory blocks 34a to 34d of the memory cell array 34 is applied to the input/output control unit 310 through a data bus L10 and is temporarily stored in the cache register 32. Subsequently, the write data stored in the cache register 32 is provided to the page buffer 360 through an internal data bus L12, and the write data provided to the page buffer 360 is stored in a memory cell which corresponds to a row designated by the row decoder 340 and a column designated by the column decoder 350. In this way, a writing operation using the cache register 32 is performed in the cache operation mode.

When the memory controller 21 applies a moving operation command to the NVM 31, the mode determiner 220 of the memory controller 21 changes the state of the mode determination signal MS. Therefore, the clock switch 240 switches and outputs the second operation clock SCLK to the line L26. The second operation clock SCLK may have a frequency that is higher than the frequency of the first operation clock FCLK outputted from the clock generator 230. In this case, data that is pre-stored in a memory block selected from among the memory blocks 34a to 34d of the memory cell array 34 is read to the data bus L10 sequentially through the page buffer 360, the internal data bus L12 and the input/output control unit 310. Afterward, a row address RA and a column address CA are newly applied for performing an operation (i.e., a copy back function) that again writes the read data in a memory cell different from the memory cell which has been selected in reading. In this case, the read data is provided to the page buffer 360 through the input/output control unit 310 without using the cache register 32.

A copy back data provided to the page buffer 360 is stored in a memory cell which corresponds to a row designated by the row decoder 340 and a column designated by the column decoder 350. In this way, the moving operation is performed at a speed higher than the operation processing speed of the cache operation mode by the control logic 300 that uses the second operation clock SCLK applied through the clock buffer 330 as an operation clock CLK.

The row address RA is applied to the row decoder 340, and the column address CA is applied to the column decoder 350. Also, a command CMD and an address ADD are applied to the input buffer 302.

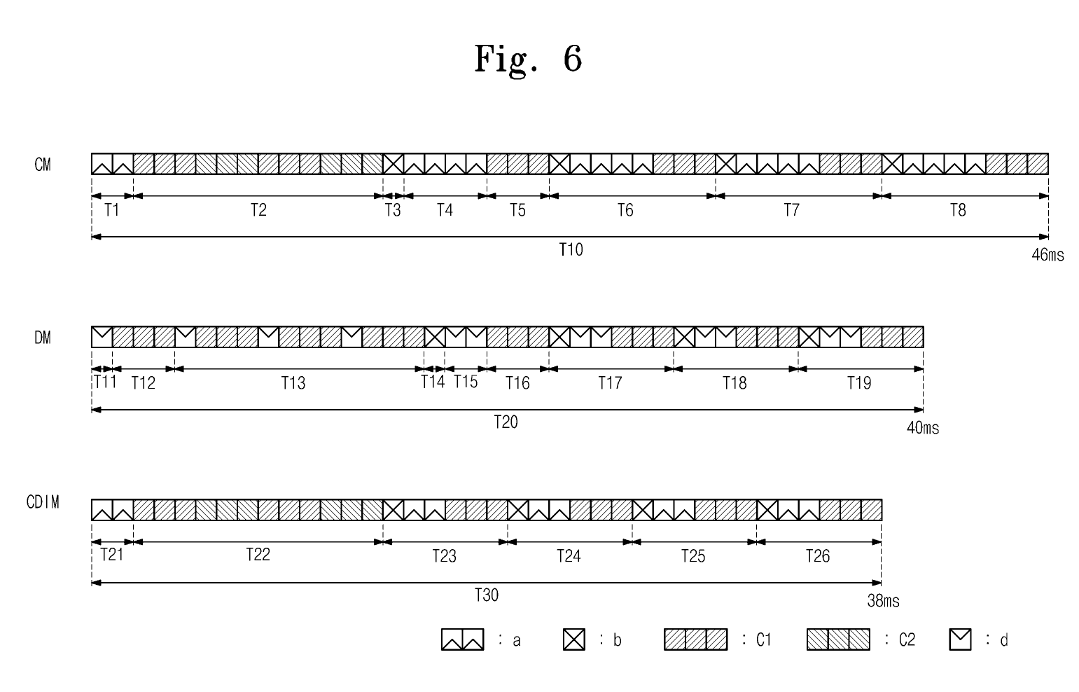

In this way, when the memory controller 21 performs control in order for the NVM 31 to operate in the cache operation mode according to a first operation command such as a writing operation command and performs control in order for the NVM 31 to operate in the high frequency operation mode such as an operation mode (for example, the DDR operation mode) different from the cache operation mode according to a second operation command such as a moving operation command, a hybrid operation mode CDIM that will be described below with reference to FIG. 6 is performed, and thus a time taken in a data processing work is shortened.

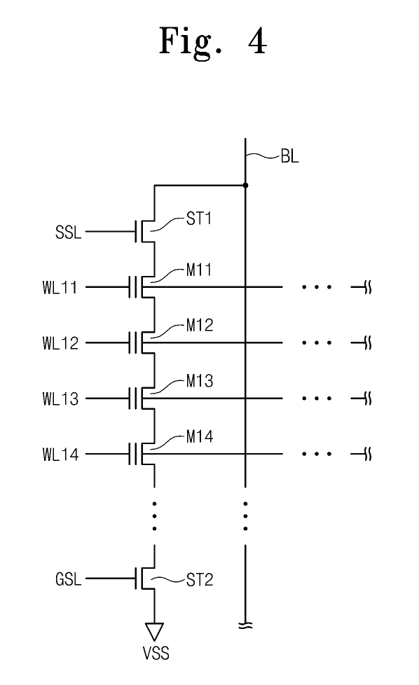

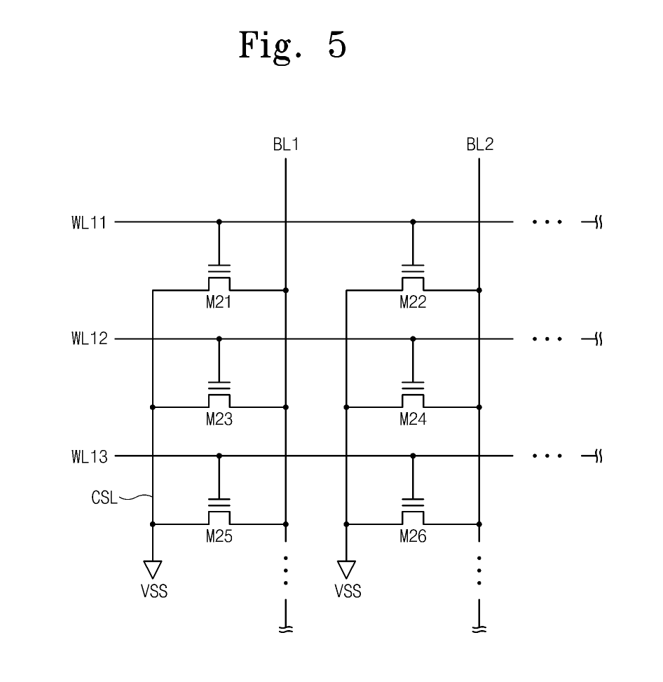

FIG. 4 is a diagram exemplarily illustrating a portion of a cell connection structure of a NAND type flash memory. FIG. 5 is a diagram exemplarily illustrating a portion of a cell connection structure of a NOR type flash memory.

Referring to FIG. 4, a plurality of word lines WL11 to WL14 are serially connected to a plurality of memory cells M11 to M14 so as to be in correspondence with a control gate, respectively. The word lines WL11 to WL14 form a string structure together with string selection transistors ST1 and ST2, and are connected between a bit line BL and a ground voltage VSS. A NAND type flash memory device has a memory cell array having a type where two or more memory cell transistors are serially connected to one bit line. A writing operation of programming data and an erasing operation of erasing stored data are performed in a Fowler-Nordheim (F-N) tunneling scheme.

Each of the memory cells M11 to M14 may be implemented as a memory cell having a charge storage layer such as a floating gate or a charge trapping layer, a memory cell having a variable resistor or the like. The memory cell array 34 may be implemented to have a single layer array structure (or called a Two-Dimensional (2D) array structure) or a multi-layer array structure (or called a Three-Dimensional (3D) array structure). An exemplary 3D array structure has been disclosed in U.S. Patent Publication No. 2008/0023747 entitled “Semiconductor Memory Device with Memory Cells on Multiple Layers”, and U.S. Patent Publication No. 2008/0084729 entitled “Semiconductor Device with Three-Dimensional Array Structure”.

Referring to FIG. 5, a NOR type structure is illustrated in which a plurality of memory cells M21 to M26 where one end is connected to a source line CSL in common are connected to intersection points between bit lines BL1 and BL2 and word lines WL11 to WL13 so as to be in correspondence, respectively. A NOR type flash memory device includes a memory cell array having a type where two or more cell transistors are connected to one bit line in parallel. A writing operation of programming data in a memory cell is performed in a channel hot electron scheme. An erasing operation of erasing data stored in a memory cell is performed in an F-N tunneling scheme.

The memory cells of FIGS. 4 and 5 may be implemented with one of various cell structures having a charge storage layer. A cell structure having a charge storage layer may be one of a charge trapping flash structure using a charge trapping layer, a stack flash structure where arrays are stacked in a multi-layer, a flash structure having no source-drain and a pin-type flash structure.

Since current consumption is high, the NOR type flash memory device of FIG. 5 is not suitable for high integration, but it is relatively suitable for speed-up. Since the NAND type flash memory device of FIG. 4 uses a relatively low cell current, the NAND type flash memory device is not suitable for speed-up, but it is relatively suitable for high integration.

FIG. 6 is a diagram showing improvement in performance of writing operations in a cache mode and moving operations in a high-frequency mode according to an embodiment of the present general inventive concept.

Referring to FIG. 6, CM indicates the cache operation mode, and DM indicates the high frequency operation mode such as the DDR operation mode. CDIM according to an embodiment of the present general inventive concept indicates the hybrid operation mode of changing an operation mode according to the type of operation being performed.

In the examples illustrated in FIG. 6, the writing operation is performed four times, the moving operation is performed four times, and a unit time for one tetragonal section is 1 ms. Accordingly, a total processing time of 46 ms is taken in the CM that operates in the cache operation mode. Also, a total processing time of 40 ms is taken in the DM that operates in the high frequency operation mode. On the other hand, a total processing time of 38 ms is taken in the CDIM according to an embodiment of the present general inventive concept.

In addition, when it is assumed that a host data writing operation is performed 128 times and the moving operation is performed 128 times, a processing time of 1154 ms is taken, and thus a processing time is shortened compared to the case of CM: 1410 ms and DM: 1280 ms.

More specifically, a section T10 in the CM of FIG. 6 is composed of the sum of sections T1 to T8. In the sections T1 and T2, a four-time writing operation is performed in the cache operation mode. Herein, the section T1 is a loading time “a” when a write data is stored in the cache register 32 during the first writing operation. A time when the write data is substantially written in a memory cell is represented as three tetragonal blocks. Therefore, in the section T2, a writing time “c1” and a writing time “c2” are alternately taken two times each and thus a total four-time writing operation is completed. A loading time “a” is shown to the outside only one time in the sections T1 and T2, but three loading times “a” are substantially hidden in the section T2. As a result, a three-time loading operation is performed together without additional time during the four-time writing operation. When the section T2 is ended, a four-time moving operation is started. In the section T3, a sensing operation is performed to sense the data of a memory cell. A sensing time “b” is represented as one tetragonal block. In the section T4, an operation that reads sensed data to the outside is performed, and an operation that again receives the data as a write data to the inside is performed. Therefore, a reading time “a” for read and an input time “a” for internal reception are summed and thereby are represented as four tetragonal blocks. That is, a time for reading data and again inputting the data to the inside is required to be taken for the moving operation. In the section T5, an operation that writes internally-input data in a newly-designated memory cell is performed. The writing time “c1” corresponds to three tetragonal blocks. When the section T5 is ended, a one-time moving operation is completed, and a total three-time moving operation is performed in the sections T6 to T8. On the assumption of times taken, a total processing time of 46 ms is taken in the section T10 of the CM.

Referring to the DM of FIG. 6, a total four-time writing operation is performed from a section T11 to a section T13 without use of a cache register. The section T11 represents a data input time “d” in the high frequency operation mode. The section T12 represents a writing time “c1” in the high frequency operation mode. A one-time writing operation is performed in the sections T11 and T12, and a total three-time writing operation is performed in the section T13. When the section T13 is ended, a four-time moving operation is started. In the section T14, a sensing operation for sensing the data of a memory cell is performed. Herein, a sensing time “b” is represented as one tetragonal block. In a section T15, an operation that reads sensed data to the outside is performed, and an operation that again receives the data as a write data to the inside is performed. Therefore, a reading time “b” for read and an input time “d” for internal reception are summed and thereby are represented as four tetragonal blocks. As a result, since the operation clock frequency of the high frequency operation mode is higher than that of the cache operation mode, an operation that reads data to the inside and an operation that again receives the read data to the inside are performed in the section T15. In a section T16, an operation that writes internally-input data in a newly-designated memory cell is performed. The writing time “c1” corresponds to three tetragonal blocks. When the section T16 is ended, a one-time moving operation is completed, and a total three-time moving operation is continuously performed in sections T17 to T19. On the assumption of times taken, a total processing time of 40 ms is taken in the section T20 of the DM.

Referring to the CDIM of FIG. 6, it is shown that a total processing time of 38 ms is taken in a section T30. First, in sections T21 and T22, a four-time writing operation is performed in the cache operation mode. Herein, the section T21 is a loading time “a” when a write data is stored in the cache register 32 during the first writing operation. A time when the write data is substantially written in a memory cell is represented as three tetragonal blocks. Therefore, in the section T22, a writing time “c1” and a writing time “c2” are alternately taken two times each and thus a total four-time writing operation is completed. A loading time “a” is shown to the outside only one time in the sections T21 and T22, but three loading times “a” is substantially hidden in the section T22. As a result, a three-time loading operation is performed together without additional time during the four-time writing operation. When the section T22 is ended, a four-time moving operation is started. Accordingly, when the writing operation is performed in the cache operation mode, time is shortened like the CM. When the section T22 is ended, a four-time moving operation is started in the high frequency operation mode. First, a one-time moving operation is performed in a section T23. Herein, a sensing operation for sensing the data of a memory cell, an operation of reading the sensed data to the outside and an operation that receives the read data as a write data to the inside are performed for 6 ms. When the section T23 is ended, a one-time moving operation is completed, and a total three-time moving operation is continuously performed in sections T24 to T26 like the DM.

In FIG. 6, it can be seen that a work processing time is shortened when the writing operation is performed in the cache operation mode relative to the high-frequency operation mode, but a work processing time is lengthened when the moving operation is performed in the cache operation mode relative to the high-frequency operation mode. Furthermore, a work processing time is shortened when the moving operation is performed in the high frequency operation mode such as the DDR operation mode relative to the cache operation mode, but a work processing time is lengthened when the writing operation is performed in the high frequency operation mode relative to the cache mode.

As a result, by changing an operation mode, the writing operation is performed in the cache operation mode. When the moving operation is performed in the high frequency operation mode such as the DDR operation mode, a work processing time is optimized or improved. Therefore, performance of a nonvolatile semiconductor memory device is enhanced, and performance of a data processing system applying the same is improved.

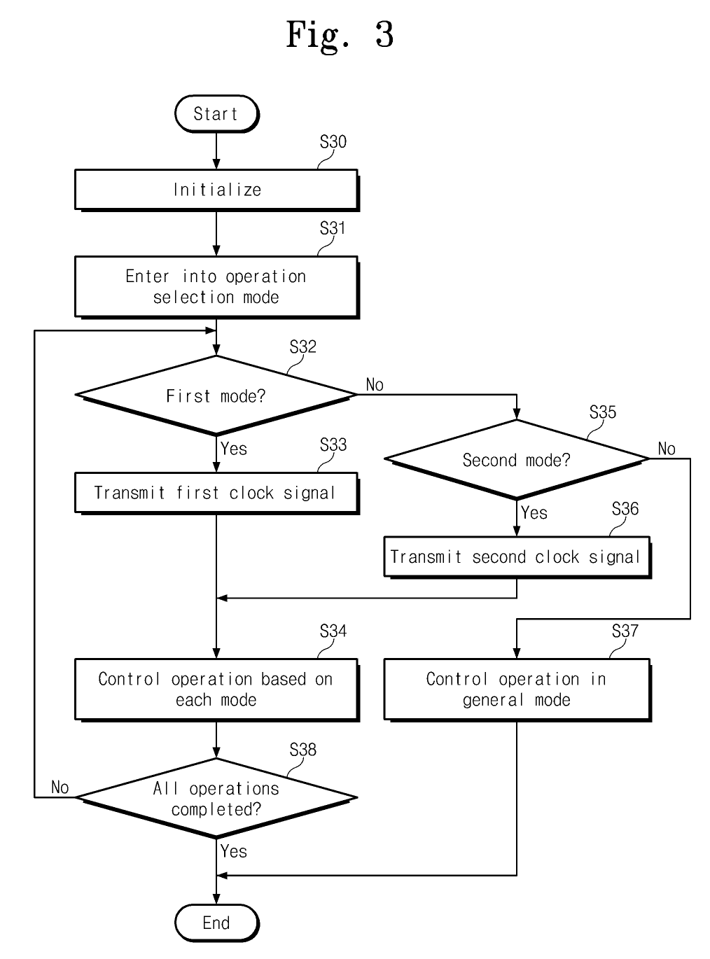

For thorough understanding of the inventive concept, the control operation of the memory controller among the elements of FIG. 2 will be described below with again reference to FIG. 3.

Referring to FIG. 3, the control circuit 200 performs initialization on all sorts of internal flags and the register 210 in operation S30. When the control circuit 200 has a mode change function according to an embodiment of the inventive concept, entering into an operation selection mode in operation S31 may be performed in default. In this case, the control circuit 200 controls the mode determiner 220 through the line L22 in order for the NVM 31 to operate in the cache operation mode during a first mode such as the writing operation, and controls the mode determiner 220 in order for the NVM 31 to operate in the high frequency operation mode such as the DDR operation mode during a second mode such as the moving operation.

The control circuit 200 checks whether a mode is a first mode in operation S32, and checks whether a mode is a second mode in operation S35. When a writing operation command using the cache register 32 is applied to the input buffer 302 of the NVM 31, the control circuit 200 determines an operation for currently performing as the first mode. When the first mode is determined, the control circuit 200 performs operation S33 and thus allows a first clock signal FCLK to be transmitted to the clock buffer 330 through the clock switch 240.

When the second mode is determined, the control circuit 200 performs operation S36 and thus allows a second clock signal SCLK to be transmitted to the clock buffer 330 through the clock switch 240. Operation control based on each mode is performed in operation S34. Herein, the NVM 31 is controlled in the cache operation mode when the first clock signal FCLK is transmitted, and the NVM 31 is controlled in the high frequency operation mode when the second clock signal SCLK is transmitted.

In the case of the cache operation mode, for example, a data load command, an address, and a cache program command are applied through the input buffer 302 of the NVM 31, and data to be written is applied through the input/output control unit 310. When the data load command is inputted, the control logic 300 of the NVM 31 allows the cache register 32 to be cleared. Subsequently, data inputted through the data bus L10 is loaded to the cache register 32. During a section where the cache program command is inputted and a ready/busy signal (R/nB) has a specific level (for example, a low level), data that is temporarily stored in the cache register 32 is moved to the page buffer 360. Data that is moved to the page buffer 360 serving as a main register is programmed in a selected memory cell. The data load command may be always inputted while programming is being performed on a previous page, and therefore, the clearing operation of the cache register 32 may be performed while programming is being performed on a previous page.

The command CMD of the NVM 31 includes a plurality of control signals (for example, ALE, CLE, /CE, /RWE and R/BB). Herein, ALE represents an address latch enable signal, CLE represents a command latch enable signal, /CE represents a chip selection signal, and /RWE represents a data fetch signal. The NVM 31 fetches data, an address or a command in response to the fetch signal. Moreover, the NVM 31 outputs data to the register 210 of the memory controller 21 in response to the fetch signal.

The NVM 31 may output data in synchronization with the low-to-high shift or high-to-low shift of the data fetch signal that is inputted through the /RWE pin. Also, the NVM 31 may output data in synchronization with the low-to-high shift and high-to-low shift of the data fetch signal that is inputted through the /RWE pin, respectively. In other words, the NVM 31 may output data in a Single Data Rate (SDR) scheme or a DDR scheme. Similarly, the NVM 31 fetches an address and a command signal in response to the data fetch signal that is inputted through the /RWE pin. Moreover, the NVM 31 may include a /RE pin and a /WE pin.

The control circuit 200 checks whether all operations are completed in operation S38. When only the section T22 in the CDIM of FIG. 6 is completed and the section T26 is not yet completed, operation S35 is performed for performing the second mode. Operation control is performed in a general mode in operation S37. Herein, the general mode denotes an operation mode other than the hybrid mode having a mode change function. Accordingly, the CM or DM of FIG. 6 may be the general mode.

Hereinafter, another embodiment of the present general inventive concept will be described.

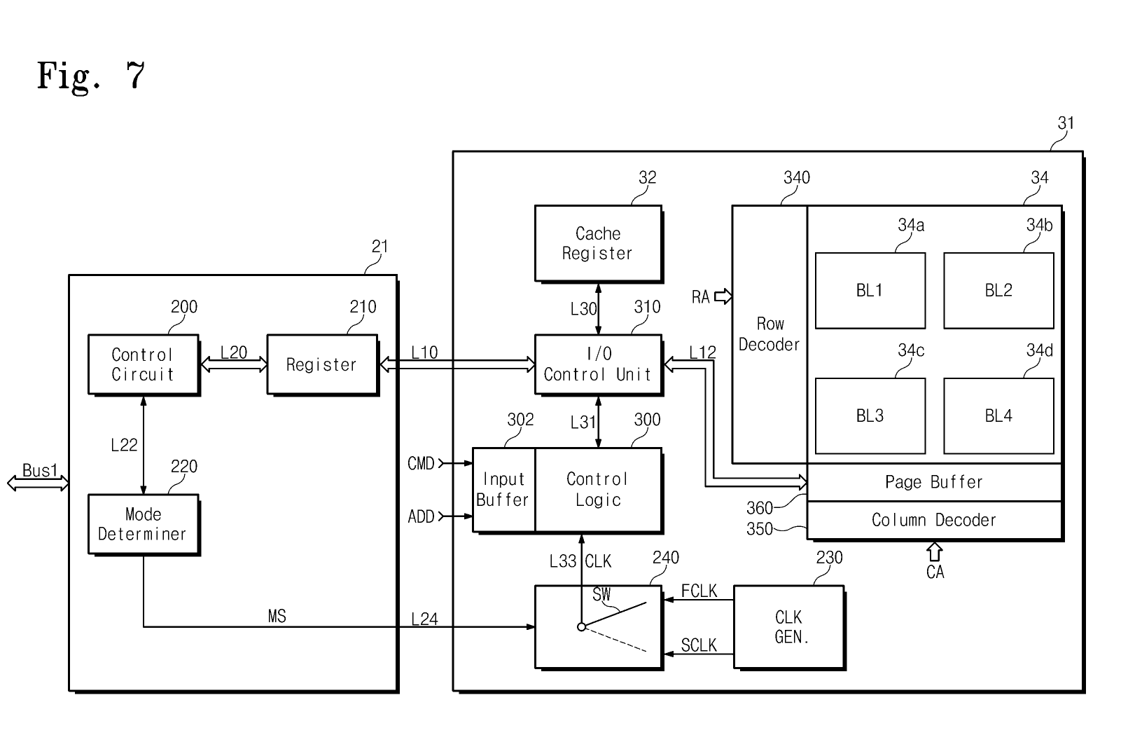

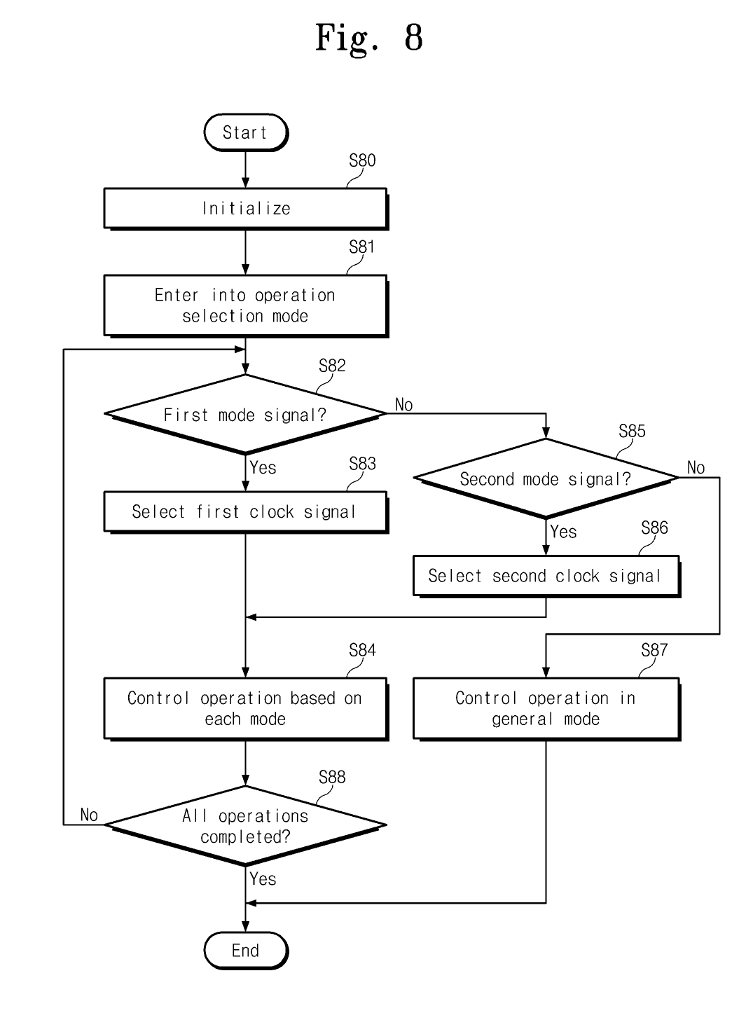

FIG. 7 is a detailed block diagram illustrating other specific examples of some elements of FIG. 1. FIG. 8 is a flowchart illustrating a control operation of a nonvolatile semiconductor memory in FIG. 2.

Referring to FIG. 7, a memory controller 21 includes a control circuit 200, a register 210, and a mode determiner 220. The NVM 31 includes a cache register 32, a memory cell array 34, a control logic 300, an input buffer 302, an input/output (I/O) control unit 310, a clock generator 230, a clock switch 240, a row decoder 340, a column decoder 350, and a page buffer 360. Comparing with FIG. 2, therefore, there is a difference in that the clock generator 230 and clock switch 240 of the memory controller 21 are removed, whereas the clock generator 230 and the clock switch 240 are included in an NVM 31. The structure of FIG. 7 can implement the internal compact configuration of the memory controller 21.

In FIG. 7, when the memory controller 21 applies a writing operation command to the NVM 31, the mode determiner 220 of the memory controller 21 outputs a mode determination signal MS through a line L24. Therefore, the clock switch 240 of the NVM 31 switches and outputs a first operation clock FCLK having a first frequency to a line L33. When the writing operation command is applied to the NVM 31, a write data to be stored in a memory block selected from among memory blocks 34a to 34d of the memory cell array 34 is applied to the input/output control unit 310 through a data bus L10 and is temporarily stored in the cache register 32. Subsequently, the write data stored in the cache register 32 is provided to the page buffer 360 through an internal data bus L12, and the write data provided to the page buffer 360 is stored in a memory cell which corresponds to a row designated by the row decoder 340 and a column designated by the column decoder 350. In this way, a writing operation using the cache register 32 is performed in a cache operation mode.

When the memory controller 21 applies a moving operation command to the NVM 31, the mode determiner 220 of the memory controller 21 changes the state of the mode determination signal MS. Therefore, the clock switch 240 switches and outputs a second operation clock SCLK having a second frequency to the line L26. The frequency of the second operation clock SCLK may be higher than the frequency of the first operation clock FCLK outputted from the clock generator 230. In this case, data that is pre-stored in a memory block selected from among the memory blocks 34a to 34d of the memory cell array 34 is read to the data bus L10 sequentially through the page buffer 360, the internal data bus L12 and the input/output control unit 310. Afterward, a row address RA and a column address CA are newly applied for performing an operation (i.e., a copy back function) that again writes the read data in a memory cell different from the memory cell which has been selected in reading. In this case, the read data is directly provided to the page buffer 360 through the input/output control unit 310 without using the cache register 32.

A copy back data provided to the page buffer 360 is stored in a memory cell which corresponds to a row designated by the row decoder 340 and a column designated by the column decoder 350. In this way, a moving operation is performed at a speed higher than the operation processing speed of the cache operation mode by the control logic 300 that uses the second operation clock SCLK applied through the clock buffer 330 as an operation clock CLK. In other words, since a clock buffer 330 is not necessary in the memory circuit of FIG. 7, the moving operation may be performed at a speed higher than in the circuit of FIG. 2, in which the second clock signal SCLK is generated in the memory controller 21 and transmitted to the clock buffer 330 of the nonvolatile memory 31.

Similarly with FIG. 2, even in FIG. 7, when the memory controller 21 performs control in order for the NVM 31 to operate in the cache operation mode according to a first operation command and performs control in order for the NVM 31 to operate in a high frequency operation mode such as a DDR operation mode according to a second operation command, a hybrid operation mode CDIM is performed like FIG. 6, and thus a time taken in a data processing work is shortened.

FIG. 8 is a flowchart illustrating a control operation of a nonvolatile semiconductor memory in FIG. 7. In FIG. 8, operations S80 to S88 are illustrated.

Referring to FIG. 8, the control logic 300 of FIG. 7 performs initialization on the cache register 32 in operation S80. When the control logic 300 has a mode change function, entering into an operation selection mode in operation S81 may be performed in default. In this case, the control logic 300 uses a first clock signal FCLK, which is applied through the line L33 during the cache operation mode, as an operation clock frequency when a first mode signal such as a writing operation is applied as a command CMD. On the other hand, the control logic 300 uses a second clock signal SCLK, which is applied through the line L33 during the high frequency operation mode, as the operation clock frequency when a second mode signal such as the moving operation is applied as a command CMD.

The control logic 300 checks whether the first mode signal is received in operation S82, and checks whether the second mode signal is received in operation S85. When a writing operation command using the cache register 32 is applied to the input buffer 302 of the NVM 31, the control logic 300 recognizes that the first mode signal is received. When the first mode signal is received, the control logic 300 performs operation S83 and thus allows the first clock signal FCLK to be outputted to the line L33.

Operation control based on each mode is performed in operation S84. Herein, when the first clock signal FCLK is transmitted, the NVM 31 is driven in the cache operation mode, and when the second clock signal SCLK is transmitted, the NVM 31 is driven in the high frequency operation mode.

The control logic 300 checks whether all operations are completed in operation S88. When only the section T22 in the CDIM of FIG. 6 is completed and the section T26 is not yet completed, operation S85 is performed for performing the second mode. Operation control is performed in a general mode in operation S87. Herein, the general mode denotes an operation mode other than the hybrid mode having a mode change function. Accordingly, the CM or DM of FIG. 6 may be the general mode.

The operation subject of FIG. 8 is the control logic 300 of the NVM 31. This is differentiated from FIG. 3 where the control circuit 200 of the memory controller 21 performs control. As a result, in FIG. 8, the control logic 300 of a nonvolatile semiconductor memory device further performs the control task of operation mode change that is performed by the memory controller 21.

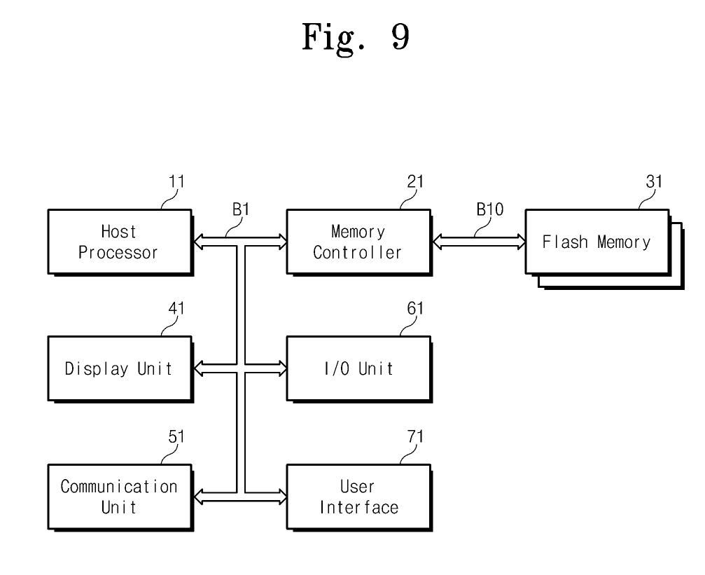

FIG. 9 is a block diagram schematically illustrating a mobile device which may apply embodiments of the inventive concept.

Referring to FIG. 9, a memory device, such as a mobile device, according to an embodiment of the present general inventive concept includes a host processor 11, a memory controller 21, a flash memory 31, a display unit 41, an input/output (I/O) unit 61, a communication unit 51, and a user interface 71.

In FIG. 9, the flash memory 31 may selectively have the configuration of FIG. 2 or the configuration of FIG. 7. Therefore, during the run time of the flash memory 31, a writing operation is performed in a cache operation mode and a moving operation is performed in a high frequency operation mode, and thus a work processing time for communication data or application data is shortened. Thus, a work requested by the memory controller 21 is processed at a relatively high speed, and thus the operation performance of the mobile device such as a smart phone is improved.

The flash memory 31 or both the flash memory 31 and the memory controller 21 in FIG. 9 may be mounted as various types of packages. For example, the packages may be one of Package on Package (PoP), Ball Grid Arrays (BGAs), Chip Scale Packages (CSPs), Plastic Leaded Chip Carrier (PLCC), Plastic Dual In-Line Package (PDIP), Die In Waffle Pack (DIWP), Die In Wafer Form (DIWF), Chip On Board (COB), Ceramic Dual In-Line Package (CERDIP), Plastic Metric Quad Flat Pack (MQFP), Thin Quad Flat Pack (TQFP), Small Outline Package (SOP), Shrink Small Outline Package (SSOP), Thin Small Outline Package (TSOP), Thin Quad Flat Pack (TQFP), System In Package (SIP), Multi Chip Package (MCP), Wafer Level Stack Package (WLSP), Die In Wafer Form (DIWF), Die On Waffle Package (DOWP), Wafer-level Fabricated Package (WFP) and Wafer-Level Processed Stack Package (WSP).

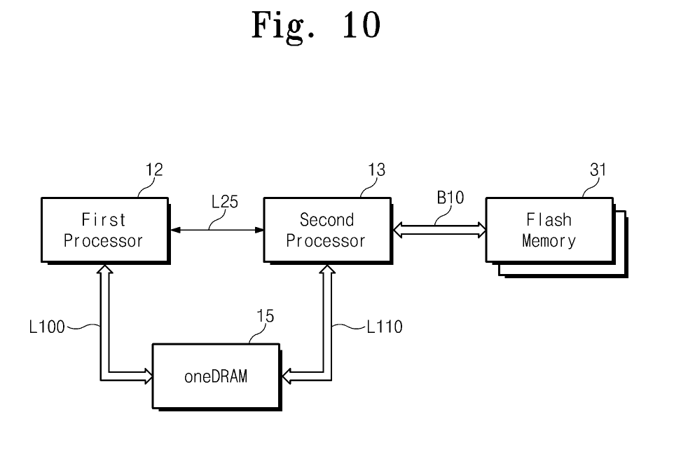

FIG. 10 is a block diagram schematically illustrating another memory device, such as a mobile device, which may apply embodiments of the present general inventive concept.

Referring to FIG. 10, a mobile device according to another embodiment of the inventive concept includes a first processor 12, a second processor 13, a flash memory 31, and a OneDRAM 15. In the present specification and claims, a OneDRAM is a chip that acts as a fusion memory. The OneDRAM 15 includes a latch type of register different from a DRAM memory cell. The OneDRAM 15 has a shared memory region that is accessed by the first and second processors 12 and 13 in common, and dedicated memory regions that the first and second processors 12 and 13 dedicatedly access, respectively. The OneDRAM 15 has a dual input/output port when it is connected to the two processors 12 and 13, and respective data processing works may be separately performed through respective ports. In FIG. 10, the flash memory 31 may selectively have the configuration of FIG. 2 or the configuration of FIG. 7. Therefore, during the run time of the flash memory 31, a writing operation is performed in a cache operation mode and a moving operation is performed in a high frequency operation mode, and thus a work processing time for communication data or application data is shortened. Thus, a work directly requested by the second processor 13 and a work indirectly requested by the first processor 12 is processed at a relatively high speed, and thus the operation performance of the mobile device is improved.

The mobile device may be one of a cellular phone, a PDA digital camera, a portable game console and an MP3 player or a notebook computer. Although not shown, the mobile device may includes a battery that supplies an operation voltage necessary for driving, and a power supply for more efficiently using the power source of the battery. Also, an application chipset and a Camera Image Processor (CIP) may be further provided. The flash memory 31 is widely used as a code storage, but depending on the case, when the flash memory 31 is used as a data storage, it may configure a Solid State Drive/Disk (SSD) that stores data with a nonvolatile memory cell.

Moreover, the flash memory may be widely used even in a home application field such as HDTVs, DVDs, routers and GPS, besides mobile devices.

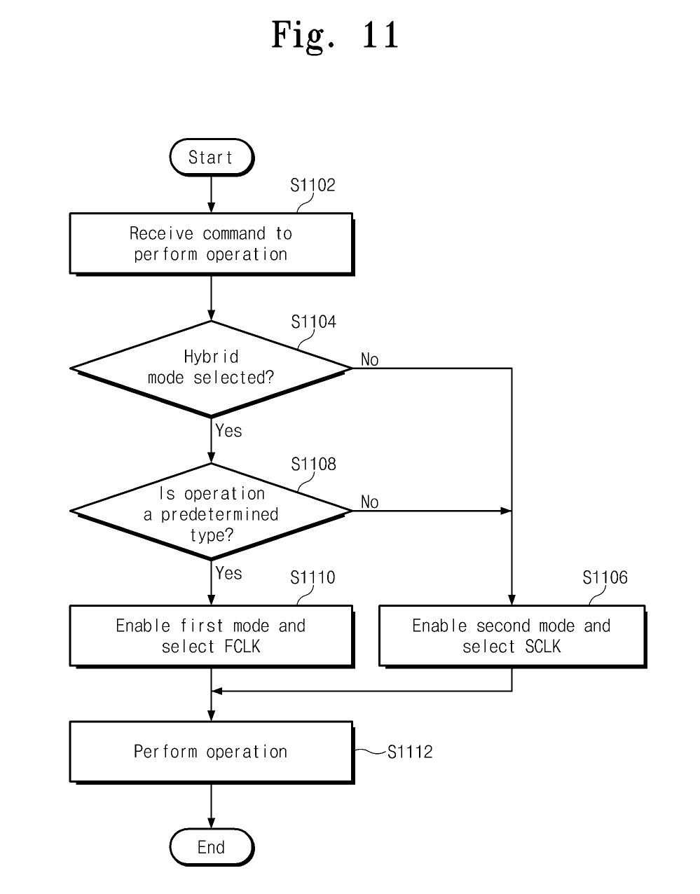

FIG. 11 illustrates an example of another method of operation according to the present general inventive concept. As illustrated in FIG. 11, a command is received in operation S1102 to perform an operation of a particular type. For example, the command may be received from the memory controller 21 to perform one of a write function and a data move function in a nonvolatile memory 31. In operation S1104, it is determined whether a hybrid mode is set. For example, the memory controller 21 may determine whether the hybrid mode is set by detecting predetermined register values or values of predetermined control data in memory.

If it is determined that the hybrid mode is not set, then the memory controller 21 may output a predetermined default clock signal. For example, the memory controller 21 may detect in memory registers that the second clock signal SCLK is the default clock signal, and may output the second clock signal SCLK to the nonvolatile memory. Similarly, with respect to FIG. 7, the memory controller 21 may output a command signal MS to select the default clock signal. Then, in operation S1112, the operation corresponding to the received command may be performed using the default clock signal.

If it is determined in operation S1104 that the hybrid mode is set, then it may be determined in operation S1108 if the received command corresponds to a first type of operation. If not, then the second clock signal SCLK may be selected or transmitted, and the operation may be performed using the second clock signal SCLK. However, if the received command corresponds to the first type of operation, then the first clock signal FCLK may be selected or transmitted in operation S1110, and the operation may be performed using the first clock signal in operation S1112.

The first and second clock signals FCLK and SCLK may have different frequencies. For example, the first clock signal FCLK may operate at a frequency lower than that of the second clock signal SCLK. In addition, the first clock signal FCLK may correspond to one type of operation mode, such as the cache operation mode, and the second clock signal SCLK may correspond to another type of operation mode, such as a high-frequency operation mode that does not utilize cache operations. In such a case, the second clock signal SCLK having the higher frequency and operating in a non-cache mode may be set as the default mode. However, the first clock signal FCLK having the lower frequency and operating in the cache mode may be set as the default mode according to an alternative embodiment.

The operation command may correspond to a read command, a write command, or a move command, for example. The memory controller 21 may be set to select the first clock signal FCLK, or the clock signal having the lower frequency and operating in the cache mode, when the write command is detected in operation S1108 and the second clock signal SCLK is set as the default mode. Alternatively, the memory controller 21 may be set to select the second clock signal SCLK, or the clock signal having the higher frequency and operating in the non-cache mode, when a move command is detected in operation S1108 and the first clock signal FCLK operating in the cache mode is set as the default mode.

When a command is received to perform a series of operations in sequence, the memory controller 21 may detect each type of operation in the series, and may store changes in operation modes in memory to change the operation mode between the lower-frequency cache mode and the higher-frequency non-cache mode at predetermined times during execution of the series of operations.

According to embodiments of the inventive concept having a function that changes an operation mode according to the kinds of operations during a run time, as described above, a processing time taken in performing of an operation mode is shortened. Accordingly, the operation performance of the nonvolatile semiconductor memory device and the operation performance of the data processing system applying the same are enhanced.

According to embodiments of the inventive concept, the nonvolatile semiconductor memory device having a function of changing an operation mode according to the kinds of operations and the operation mode change method shorten a processing time taken in performing of the operation mode. Accordingly, in the nonvolatile semiconductor memory device and the data processing system applying the same, operation performance is enhanced. In addition, a selection between a cache mode and a non-cache mode may be made by the memory controller of the present general inventive concept based on a type of operation to be performed, and the memory controller need not receive a command from an external device to perform the operation in the cache mode or the non-cache mode.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit the stored code through carrier waves or signals (e.g., wired or wireless data transmission through the Internet). Also, functional programs, codes, and code segments stored in memory and executable by one or more processors to accomplish the present general inventive concept can be easily construed by programmers skilled in the art to which the present general inventive concept pertains.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the general inventive concept is to be determined by the broadest permissible interpretation of the following claims and their equivalents, and shall not be restricted or limited by the foregoing detailed description. For example, even when there are three or more operation kinds, the inventive concept may change an operation to an appropriate operation mode without departing from the spirit and scope of the inventive concept. Moreover, it is apparent that the control logic of a nonvolatile semiconductor memory device may further perform the control task of operation mode change that is performed by a memory controller, and the memory controller may further perform the control task of operation mode change that is performed by the control logic of the nonvolatile semiconductor memory device.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A method of driving a nonvolatile semiconductor memory device including a cache register for supporting a cache operation mode, the method comprising:
driving the nonvolatile semiconductor memory device in the cache operation mode according to a first operation command; and
driving the nonvolatile semiconductor memory device in an operation mode different from the cache operation mode according to a second operation command.

2. The method of claim 1, wherein the first operation command is a writing operation command.

3. The method of claim 1, wherein the second operation command is a moving operation command when the first operation command is a writing operation command.

4. The method of claim 1, wherein the operation mode different from the cache operation mode is a Double Data Rate (DDR) operation mode.

5. The method of claim 1, wherein an operation clock frequency, which is used in the nonvolatile semiconductor memory device under the second operation command, differs from an operation clock frequency which is used in the nonvolatile semiconductor memory device under the first operation command.

6. The method of claim 1, wherein an operation clock frequency, which is used in the nonvolatile semiconductor memory device under the second operation command, is higher than an operation clock frequency which is used in the nonvolatile semiconductor memory device under the first operation command.

7. The method of claim 1, wherein the nonvolatile semiconductor memory device is a NAND flash memory device.

8. The method of claim 1, wherein a memory device configuring the cache register is configured in a type different from a type of a memory cell which configures a memory cell array of the nonvolatile semiconductor memory device.

9. A nonvolatile semiconductor memory device comprising:
a cache register supporting a cache operation mode;
a memory cell array comprising a plurality of memory blocks which comprise a plurality of memory cells nonvolatilely storing data; and
a control driver to drive the cache register and the memory cell array in the cache operation mode according to a first operation command, and to drive the memory cell array in an operation mode different from the cache operation mode according to a second operation command.

10. The nonvolatile semiconductor memory device of claim 9, wherein the first operation command is a writing operation command which indicates loading of data into the cache register and writing of the loaded data in the memory cell array.

11. The nonvolatile semiconductor memory device of claim 9, wherein when the first operation command is a writing operation command, the second operation command is a moving operation command which indicates reading of data from a memory cell and writing of the read data into another memory cell.

12. The nonvolatile semiconductor memory device of claim 9, wherein the operation mode different from the cache operation mode is a Double Data Rate (DDR) operation mode.

13. The nonvolatile semiconductor memory device of claim 9, wherein an operation clock frequency, which is used under the second operation command, differs from an operation clock frequency which is used under the first operation command.

14. The nonvolatile semiconductor memory device of claim 9, wherein an operation clock frequency, which is used in the nonvolatile semiconductor memory device under the second operation command, is higher than an operation clock frequency which is used in the nonvolatile semiconductor memory device under the first operation command.

15. The nonvolatile semiconductor memory device of claim 14, wherein a memory device configuring the cache register comprises a latch type of volatile memory cell.

16. A data processing system comprising:
a nonvolatile semiconductor memory device comprising a cache register supporting a cache operation mode, and a memory cell array comprising a plurality of memory blocks which comprise a plurality of memory cells nonvolatilely storing data; and
a memory controller to control the nonvolatile semiconductor memory device to operate in the cache operation mode according to a first operation command, and to operate in an operation mode different from the cache operation mode according to a second operation command.

17. The data processing system of claim 16, wherein an operation clock frequency, which is used in the nonvolatile semiconductor memory device under the second operation command, is higher than an operation clock frequency which is used in the nonvolatile semiconductor memory device under the first operation command.

18. The data processing system of claim 16, wherein the nonvolatile semiconductor memory device is a OneNAND flash memory device.

19. The data processing system of claim 16, wherein when the first operation command is a writing operation command which indicates loading of data into the cache register and writing of the loaded data in the memory cell array, the second operation command is a moving operation command which indicates reading of data from a memory cell and writing of the read data into another memory cell.

20. The data processing system of claim 19, wherein the data processing system is comprised in a mobile device.

21. A method of controlling a memory device, the method comprising:
receiving a command to perform an operation of the memory device;
determining whether the command corresponds to a first type of operation; and
when the command corresponds to the first type of operation, performing the operation in a cache mode, and when the command does not correspond to the first type of operation, performing the operation in a non-cache mode.

22. The method of claim 21, wherein performing the operation in the cache mode includes selecting a first clock signal to perform the operation, and
performing the operation in the non-cache mode includes selecting a second clock signal different from the first clock signal to perform the operation.

23. The method of claim 22, wherein the second clock signal has a frequency higher than the first clock signal.

24. The method of claim 21, wherein the first operation is a write operation to write data into a memory block of the memory device.

25. The method of claim 21, further comprising:
after receiving the command, determining whether a hybrid mode is set; and
when it is determined that the hybrid mode is set, determining whether the command corresponds to the first type of operation, and when it is determined that the hybrid mode is not set, setting the mode to a predetermined one of the cache mode and the non-cache mode to perform the operation without determining whether the command corresponds to the first type of operation.

26. A nonvolatile memory device, comprising:
a memory cell array to store data; and
a control unit to receive a command to perform an operation, to execute the operation in a cache mode when the operation is a first type of operation, and to execute the operation in a non-cache mode when the operation is not the first type of operation.

27. The non-volatile memory device of claim 26, further comprising:
a clock generator to generate a first clock signal having a first frequency and a second clock signal having a second frequency different from the first clock signal; and
a clock selection circuit to select and output the first clock signal to execute the operation when the operation is performed in the cache mode, and to select and output the second clock signal to execute the operation when the operation is performed in the non-cache mode.

28. The non-volatile memory device of claim 27, wherein the second clock signal has a frequency higher than the first clock signal.

29. The non-volatile memory device of claim 26, further comprising a cache register,
wherein performing the operation in the cache mode includes storing data in the cache register and transmitting the data from the cache register to the memory cell array to store the data in the memory cell array.

30. A memory controller, comprising:
a control circuit to receive a command to perform an operation corresponding to a nonvolatile memory controlled by the memory controller, to determine whether the operation corresponds to a predetermined operation type, and to output a first mode determination signal to perform the operation in a cache mode when the operation corresponds to the predetermined type and to output a second mode determination signal to perform the operation in a non-cache mode when the operation does not correspond to the predetermined type.

31. The memory controller of claim 30, further comprising:
a clock generator to generate a first clock signal having a first frequency and a second clock signal having a second frequency different from the first clock signal; and
a clock selection circuit to select and output the first clock signal to execute the operation when the operation corresponds to the predetermined operation type, and to select and output the second clock signal to execute the operation when the operation does not correspond to the predetermine operation type.

32. The memory controller of claim 30, further comprising:
a register to store data indicating whether a hybrid mode is selected,
wherein the control circuit detects whether the hybrid mode is selected, and
when the hybrid mode is selected, the control circuit determines whether the operation corresponds to the predetermined type of operation, and when the hybrid mode is not selected, the control circuit outputs a predetermined one of the first and second mode determination signals regardless of whether the operation corresponds to the predetermined type of operation.

33. An electronic device, comprising:
a nonvolatile memory device to store data; and
a memory controller to receive a command to control the nonvolatile memory to perform an operation, to determine whether the operation corresponds to a predetermined operation type, and to output a first mode determination signal to control the nonvolatile memory device to perform the operation in a cache mode when the operation corresponds to the predetermined type and to output a second mode determination signal to control the nonvolatile memory device to perform the operation in a non-cache mode when the operation does not correspond to the predetermined type.

34. A memory device, comprising:
a memory cell array; and
a controller to control the memory cell array to perform a first operation using a first clock having a first speed in a first mode, and to perform a second operation different from the first operation using a second clock having a second speed different from the first speed in a second mode different from the first mode.
